(19) United States
(12) Patent Application Publication
(10) Pub. No.: US 2023/0058191 A1
(43) Pub. Date: Feb. 23, 2023

(54) Additional Circuit for Process Supply Lines of a Welding or Cutting Torch and Hose Pack Having an Additional Circuit

(71) Applicant: Alexander Binzel Schweisstechnik GmbH & Co. KG, Buseck (DE)

(72) Inventors: Sascha ROSE, Fernwald (DE); Jonathan Moore, Oxfordshire (GB)

(73) Assignee: Alexander Binzel Schweisstechnik GmbH & Co. KG, Buseck (DE)

(21) Appl. No.: 17/796,696

(22) PCT Filed: Feb. 1, 2021
(86) PCT No.: PCT/EP2021/052297

§ 371 Date: Aug. 1, 2022

(30) Foreign Application Priority Data
Feb. 4, 2020 (DE) 10 2020 102 792.3

(51) Int. Cl. B23K 9/10; B23K 9/32

(52) U.S. Cl. CPC B23K 9/1043; B23K 9/32

(57) ABSTRACT

A supplementary circuit for process supply lines of a welding torch or cutting torch has at least one connection device to a welding current source arranged on it, wherein electrical energy and other media are conveyed to the welding torch or cutting torch via the connection device and via a process supply line that is preferably held in a hose pack of the welding torch or cutting torch. Electrical energy for operating a peripheral device, such as a sensor, a drive unit or a controller for the drive unit, is branched or tapped off from at least one electrical process supply line without significantly affecting the electric arc process. The supplementary circuit provided for branching or tapping off the electrical energy is coupled in parallel onto the welding current circuit. This coupling is based on direct ohmic contact or on a galvanic coupling.

### CROSS-REFERENCE TO RELATED APPLICATIONS

This application is a national stage application (under 35 USC § 371) of PCT/EP2021/052297, filed Feb. 1, 2021, which claims benefit of DE 102020102792.3, filed Feb. 4, 2020, the contents of each of which is incorporated by reference herein.

### BACKGROUND OF THE INVENTION

### Technical Field and State of the Art

The invention relates to a supplementary circuit for process supply lines of a welding torch or cutting torch, as well as to a hose pack having a supplementary circuit.

Thermal joining methods use energy in order to melt workpieces and join them. Aside from electrode processes (MMAW—manual metal arc welding), metal processing technology commonly employs especially “MIG” and “MAG” welding processes (“MSG”—metal shielding-gas—processes) as well as “TIG” and “plasma” arc processes with their laser hybrid methods. Likewise an objective of the invention are welding torches on the basis of plasma and plasma hybrid, and so are processes in which a hot wire is fed in, which consequently encompasses not only the above-mentioned processes but also laser cutting processes.

When it comes to shielding gas-assisted arc welding methods employing a consumable electrode (MSG), “MIG” stands for “metal inert gas” and “MAG” stands for “metal active gas”. In the case of shielding gas-assisted arc welding methods employing a non-consumable electrode (TSG), “TIG” stands for “tungsten inert gas”. The hose packs according to the invention can be configured for machine-controlled welding torches or cutting torches that are arranged on a robot arm. However, manual or automated torches are likewise conceivable.

Generally speaking, arc welding devices generate an arc between the workpiece and a consumable or non-consumable welding electrode in order to fuse the material that is to be welded.

A stream of shielding gas protects the material that is to be welded as well as the welding site against the atmospheric gases.

In this context, the welding electrode is provided on a torch body of a welding torch that is connected to an arc welding device. The torch body normally has a group of internal components that carry welding current and that conduct the welding current from a welding current source in the arc welding device to the tip of the torch head onto the welding electrode, where it then generates the arc to the workpiece.

The shielding gas stream flows around the welding electrode, the arc, the welding bath and the heat-affected zone on the workpiece, and in this process, it is fed to these areas via the body of the welding torch. A gas nozzle conveys the shielding gas stream to the front end of the torch head, where the shielding gas stream exits from the torch head in an approximately annular pattern around the welding electrode.

During the welding procedure, the arc generated for the welding heats up the workpiece that is to be welded as well as any optionally added welding material, so that these are fused.

Aside from welding, soldering is also an option when it comes to joining sheet metal components. Unlike in the case of welding, with soldering, it is not the workpiece that is melted but rather only the filler material. The reason is that, in soldering, two edges are joined together by the solder as the filler material. The melting temperatures of the solder material and of the component materials are very different, which is why only the solder melts during processing. Aside from TIG, plasma and MIG torches, LASERS are likewise suitable for soldering.

The arc soldering processes can be broken down into metal shielding-gas soldering (MSG-S) processes and tungsten shielding-gas soldering (TSG-S) processes. For the most part, copper-based materials in wire form, whose melting ranges are lower than those of the base materials, are used here as the filler material. In terms of the equipment employed, the principle of MSG arc soldering is largely identical to that of MSG welding, using filler material in wire form.

During soldering or welding such as, for example, when electric arc welding is used on metals, depending on the composition and the degree of contamination of the materials to be welded or soldered, somewhat large amounts of waste gases or fumes that are partially harmful to health are generated which might not only impair the visibility of the welding or soldering site, but also cause harm to the health of the user since the eyes and breathing organs could become irritated. Consequently, various apparatuses and methods have been developed in actual practice which allow the waste gases to be extracted as close as possible to the place on the torch where they are generated.

PCT international application WO 2006/042572 A1 describes a sensor means for detecting the position and/or positional changes of the torch, as a result of which at least one characteristic value of the joining, cutting or surface-treating method, especially the welding method, can be influenced as a function of the position and/or positional changes that have been detected.

PCT international application WO 2013/166247 A1 discloses systems and methods for automatically regulating the fume stream that has been drawn in by a welding-fume gun. The device has a vacuum system that is configured to extract a stream of vacuumed fume through an internal passage of a welding-fume gun. Likewise provided is a sensor to measure the stream of vacuumed vapor.

In the case of shielding gas-assisted arc welding methods employing a consumable electrode, so-called wire-feed devices comprise at least one drive element that serves to exert a pressing force onto the wire or wire electrode that is to be conveyed while, at the same time, imparting a forward-feed motion onto it.

If the contact pressure or pressing force is too low, so-called slippage can occur between the drive element and the wire or wire electrode. Slippage, however, should be prevented at all costs since this would cause an insufficient amount of the material of the consumable wire electrode to enter the front end of the welding or soldering torch in the melting zone.

Slippage is also dependent on the feed speed at which the wire is being advanced. If this speed is too high, this can also lead to undesired slippage. For this reason, the speed of an advancing object, especially a wire, can be measured by means of contact or else in a contactless manner.

German laid-open document DE 10 2008 039 025 A1 and European patent application EP 2 159 536 A2 disclose a method involving sensors for contactless measurement of the speed and/or the length of a longitudinally moving strand of material.

European patent application EP 1 352 698 A1 discloses a wire-feed device for welding installations having an apparatus for measuring the wire speed. A light source illuminates a section of the wire. A CCD sensor is aimed at the surface of the wire and it detects the texture on the wire surface.

For purposes of cooling the handle of a welding or cutting torch and/or the inside of the handle, especially the entire handle interior, of the welding or cutting torch and/or a gas nozzle outside of the interior of the gas nozzle on the side associated with the arc, European patent EP 2 666 576 B1 discloses a conveying apparatus, especially a fan or a compressor which conveys, as cooling air, ambient air through at least one cooling channel of the welding or cutting torch.

European patent EP 3 235 105 B1 discloses a system for branching off energy from a welding cable. An energy extraction apparatus is positioned and configured in the vicinity of the welding cable in order to inductively acquire electric energy from the welding cable. The energy extraction system also has a rectifier that is electrically coupled to the energy extraction system and that is configured to convert the electric energy extracted from the welding cable into electric direct current. In other words, this state of the art explicitly discloses an inductively coupled supplementary circuit that is not fastened to the welding cable for direct ohmic contact or galvanic coupling. A drawback of such inductively coupled supplementary circuits is that then, electric energy can only be drawn from the welding current cable if the magnetic field around the welding current cable changes. This requires current ripples or current changes.

U.S. Pat. Appln. No. 2018/0021873 A1 discloses a welding apparatus with current line communication. The current supply is coupled to a welding control apparatus that is intended to allow the user to select welding processes and welding settings remotely from the current supply. This welding control apparatus supplies current to one or more auxiliary devices in the vicinity of the welding seam and it is connected to the current source via an auxiliary line.

German utility model DE 20 2019 001 241 U1 relates to an overvoltage protector with fault indicator.

The above-mentioned sensors or sensor means for detecting the position and/or positional changes of the torch, or else the sensors for measuring the speed and/or length of the wire, or the sensors for measuring the vacuumed vapor stream as well as the cooling fan, or the drives for advancing the wire all constitute so-called peripheral devices.

When it comes to the prior-art welding or soldering devices, additional consumers, particularly also displays and sensing devices can be supplied, on the one hand, by means of connectors that are specific to the source of current such as, for instance, so-called bus cables, which are integrated into the manufacturer's current-source specific hose pack connector. A drawback of this is that, in order to prevent users from replacing the components, especially the hose packs, as a rule, current source manufacturers do not open these connectors to third parties.

On the other hand, it is conceivable for energy to be branched off from open lines in the current source, especially of the wire drive motor. However, the disadvantage here is that such housings are closed off in order to prevent soiling and to adhere to the safety requirements, but also to prevent external branching off of energy.

Likewise conceivable is a separate supply connector on the current source, for example, by means of a USB connector. However, very few current sources have such connectors which normally are intended primarily for data exchange.

A separate energy supply with a power adapter entails the disadvantage that, on the one hand, another power adapter is needed and that the power adapters normally use monophasic alternating current and not three-phasic alternating current, which is not readily available, especially not in work shops and at construction sites. Moreover, there are numerous country-specific connectors.

There is also another particular challenge in putting forward an energy supply that can be controlled independently of the welding process. Even though it is conceivable to store energy in batteries or accumulators or capacitors, having batteries or accumulators as energy storage units for peripheral devices could create transportation problems due to the special safety requirements as well as environmental and disposal issues.

Before the backdrop of the above-mentioned disadvantages, the invention is based on the objective of putting forward an autonomous energy supply for peripheral devices which is integrated into the process supply line and which does not significantly influence the arcing process.

### SUMMARY OF THE INVENTION

The invention relates to a supplementary circuit for process supply lines of a welding torch or cutting torch having at least one connection device to a welding current source arranged on it, wherein electric energy and other media are conveyed to the welding torch or cutting torch via the connection device and via supply lines that are preferably held in a hose pack of the welding torch or cutting torch.

According to a first embodiment of the invention, electric energy for operating a peripheral device such as for example, a sensor, a drive unit or a fan, is branched off from at least one electric process supply line.

In other words, this embodiment of the invention puts forward an autonomous energy supply without a physical connection to current-source specific connectors. It can especially be an electric current circuit connected in parallel that can process a highly variable input signal in terms of polarity, voltage and dynamics; in particular, frequencies for the current and/or voltage of direct-current (DC) processes, direct-current pulse-control processes (DC pulses) up to 20 kHz as well as alternating current (AC) processes within the range from under 50 Hz up to 200 Hz can be processed.

As an alternative, on the basis of a simplified setup, the current circuit can be adapted to specific input signals, especially the DC processes that prevail in MSG applications. This embodiment can also be employed in order to bring in additional energy in the so-called hot-wire processes that are mostly used in TIG and plasma processes as well as laser processes.

The connection device provided on the hose pack serves to establish electrical and mechanical contact of the hose pack with the welding current source. The process supply lines that convey electric energy and other media such as shielding gas or the welding wire to the welding or cutting burner are arranged in the hose pack. Accordingly, if the hose pack is electrically connected to the welding current source, an electric current circuit is closed via the arc, the torch with the hose pack and the ground cable or the ground line.

Moreover, the invention is advantageous in that this process current circuit does not need to be closed in order for electric energy to be branched off for purposes of operating the peripheral device via the supplementary circuit according to the invention. Instead, it is sufficient that voltage is present for the process current circuit—this happens especially at the start of the process in that voltage is present already at the moment when the wire is conveyed, without the process current circuit being closed since the wire is not yet touching the workpiece or else the arc is not yet burning.

This energy supply can be used for peripheral devices such as, for instance, wire drives and their controls, for sensors, especially temperature sensors or gyro sensors, or for communication units such as Bluetooth transmitters or Bluetooth receivers, WLAN devices or LED lighting or for mass air-flow sensors and the like.

Moreover, it is also possible to supply fans, on the one hand, for cooling purposes, especially as so-called forced-air cooling and, on the other hand, to also supply fans for fume extraction in welding applications.

As mentioned, drives can be operated with this supply since the output of the autonomous energy supply is sufficient for this as well. Moreover, supplying appertaining drive control means is also an obvious and meaningful application. The output needed for the drives can amount to up to 100 W.

Such peripheral devices make high demands in terms of the speed of the circuit; in particular, a response time of less than 50 ms should be ensured. In other words, the output of the branched-off current circuit is needed right away. The circuit according to the invention ensures this.

As a rule, the open-circuit voltage of the power adapter of the welding device is already enough to provide a sufficiently high output for the peripheral devices. Often, the open-circuit voltage is limited to 113 V or 141 V.

Most peripheral devices have a certain time delay between the application of voltage and the response of the peripheral device. In actual practice, especially for MSG applications, however, it is advantageous for the wire to be conveyed a few millimeters at the start until a short circuit occurs. During this time, voltage is already present. Consequently, the parallel circuit can already branch off energy, as a result of which controls are initiated and drives are started, even if the welding process is not yet ongoing.

Moreover, the circuit according to the invention is also more compact than prior-art current sources since there is no need for an additional power adapter or for additional lines for peripheral devices.

Furthermore, the circuit is very versatile in terms of its use, that is to say, it can be employed with a wide variety of current sources, especially for numerous and varied power adapters of welding devices since, as a rule, the welding current at the welding site is always the same. The voltage during operation of the welding torch can amount to about 30 V at 300 A.

In order for the supplementary circuit to provide an output of, for example, 30 W, which is usually sufficient to supply a wire drive unit in a handheld torch, all that is thus necessary is for a current of 1 A to flow through the parallel circuit. Measurements have at times shown values that are even considerably lower, for example, within the range from 0.3 A to 0.5 A.

Even though this flow of current is thus not available to the arc, the absolute magnitude of the current flow falls within the range of normal process fluctuations during arc processes and it does not influence the process stability or the process regulation in any significant way. Therefore, the supplementary circuit can be used without the need to carry out parameter adaptations for the welding process or changes in the parameter settings in welding procedure specifications, so-called WPS.

According to an embodiment of the invention, the supplementary circuit provided for branching off energy is coupled electrically in parallel and preferably galvanically to the welding current circuit, it is especially coupled onto the process supply line. The term welding current circuit refers to the current circuit that is formed between the welding torch with the arc, the hose pack and the ground line of the welding device.

In contrast to supplementary circuits that are based on an inductive operating principle, the supplementary circuit according to the invention functions instead on the basis of the galvanic coupling or the direct ohmic contact, even in the case of a perfect direct current since there is no need for any change in the magnetic flow in order to generate energy.

The inductively coupled supplementary circuits known from the state of the art are fastened on the welding cable not for a direct ohmic contact or a galvanic coupling. The inductively coupled supplementary circuit differs from the parallel connection with the galvanic coupling in terms of its physical operating principle since it can only draw electric energy from the welding current cable if the magnetic field around the welding current cable changes.

Owing to the parallel connection according to the invention, in contrast, ripple effects are not necessary since there is no need for a change in the magnetic flow. By means of the parallel connection with direct ohmic contact or galvanic coupling, electric energy can be recovered even in the case of a perfect direct current.

It can be provided for the supplementary circuit to be integrated into an expanded connector housing on the side associated with the machine. This is advantageous because this housing is already necessary anyway for the delivery of media, for instance, wire, gas, water and signals, and also because the energy is supplied via the peripheral device.

As an alternative, it is conceivable for the supplementary circuit to be integrated into a separate adapter. This is done preferably in the electric ground line since, in contrast to the hose pack line, only electric current flows in it, in other words, no other media such as gas, wire and water. This makes the implementation easier on this side, although this is in principle also possible on the side associated with the hose pack.

In other words, such an adapter could also be integrated into the side of the torch connector associated with the machine. Likewise conceivable is a separate adapter, that is to say, one not integrated into the hose pack. This is possible if no additional potential-equalized connection capabilities are present on the welding current source aside from the plus and minus poles for the welding current circuit. Particularly in the case of the ground connections, usually the minus pole, very often there is a connection capability on the front or rear side of the device; and yet, the welding current sources at times also have another connection capability that has the same potential as the connection on the side associated with the torch, in other words, usually the plus pole.

According to another advantageous variant, the supplementary circuit comprises a rectifier, especially a bridge rectifier in order to convert alternating voltage into direct voltage. The circuit according to the invention allows direct (DC) as well as alternating (AC) voltage operation and also pulse-control operation (DC and AC).

According to another advantageous embodiment of the invention, it is possible, as an alternative, to dispense with the rectifier in the circuit, as a result of which the circuit can be used exclusively for DC processes. In this case, a reverse-polarity protector is provided wherein protection against reverse polarity is implemented by means of at least a transistor, a diode, especially a Zener diode, and at least an electric resistor. In this manner, with the right connection and thus a correct polarity, the circuit delivers the requisite electric energy. Correspondingly, in the case of the wrong connector for the poles, no electric energy is released but the welding device is not damaged, either. As a rule, the polarity on the side associated with the torch is positive. It can be provided for the user to be informed about a fault. It is especially conceivable for this to be in the form of an optical signal, for example, a light element that is integrated into the supplementary circuit in the form of an optical display means. As an alternative or in addition within the scope of the invention, it is likewise conceivable for erroneous polarity to be indicated through the modality of an acoustic signal means.

In a refinement of the invention, the supplementary circuit has a switching DC-to-DC converter, especially a step-down converter, wherein the output voltage of the converter can deviate from the value of the input voltage of the converter. The step-down converter is also referred to as a buck converter. This step-down converter makes it possible to process the voltage and current values commonly encountered in welding devices. These values range, for instance, from 20 V/100 A to 30 V/300 A during processing involving steel welding procedures, and 113 V and 141 V, respectively, during no-load operation.

In particular, the output voltage can be at a constant 48 V and thus above the process voltage. Moreover, other forms of converters are also possible such as the serial connection of step-up converters or step-down converters or else voltage converters with a wide-range input.

According to another advantageous embodiment of the invention, the input voltage for the DC-to-DC converter is the direct voltage that is output by the rectifier. Generally speaking, the DC-to-DC converter can only be operated with positive DC voltage. For this reason, it is necessary to rectify the AC or the negative voltages. Additional advantages are reverse-polarity protection and operation with AC voltage.

The rectifier prevents the charge from the capacitor/energy storage means from flowing back into the welding process.

It can be provided for the supplementary circuit to have at least one overcurrent protector, that is to say, fuses for cutting out the electric current if a stipulated current strength has been exceeded over a prescribed time, especially in case of electric short circuits or overloads.

According to another advantageous embodiment of the invention, the supplementary circuit has an inductor, especially an electromagnetic coil for damping voltage peaks of the welding current source that can happen with the high-frequency “metallurgical” pulses, for instance, pulses within the kHz range.

In a refinement of the invention, the supplementary circuit has at least one electric energy storage means, especially a capacitor or an accumulator or a battery that serves to store electric charge in an electric field; preferably the energy storage means is provided for feeding electric energy to the DC-to-DC converter and/or for stabilizing the voltage of the supplementary circuit. An energy storage unit is particularly advantageous in the case of peripheral devices such as control units for drives since their capacity is sufficient to supply the electronic control units and also to operate the drives after the process current has been switched off. It is also possible to store energy for the subsequent processes and thus further minimize the initial delay.

According to another variant of the invention, the supplementary circuit has a suppressor diode to protect the supplementary circuit, especially the DC-to-DC converter, against undesired voltage peaks.

In an advantageous refinement of the invention, an additional energy buffer, particularly a super capacitor, is provided for buffering electric energy. An advantageous aspect of circuits with capacitors is the charging speed wherein, at the same volume as accumulators, the capacitors display a considerably greater charging speed. However, in the case of brief applications, standard capacitors can still be too slow, which is why super capacitors are then utilized.

According to another advantageous embodiment of the invention, the overcurrent protectors and the inductor are installed upstream from the DC-to-DC converter. The upstream overcurrent protector can be a fusible cutout that switches off in case of a fault and/or polyfusible cutouts that switch off in case of overloads. The inductor especially serves to reduce current peaks during the switch-on procedures as well as in case of load changes, especially short circuits and their resolution.

Another variant provides for the rectifier as well as the at least one energy storage means and the suppressor diode to be installed upstream from the DC-to-DC converter. In this context, the rectifier serves to protect against negative voltages and reverse polarity. Transversal diodes (TVS), in turn, serve to protect against high voltage peaks. Capacitors stabilize the voltage, particularly by filtering voltage peaks.

In a refinement, at least one energy storage means is installed downstream from the DC-to-DC converter. Fundamentally speaking, energy storage means serve to ensure a safe condition during switch-off procedures, which especially encompass a final position movement of the wire, the ramping down of control units as well as data-saving operations.

Additional objectives, advantages, features and application possibilities of the present invention ensue from the description below of an embodiment making reference to the drawing. In this context, all of the described and/or depicted features, either on their own or in any meaningful combination, constitute the subject matter of the present invention, also irrespective of their compilation in the claims or the claims to which they refer back.

### DESCRIPTION OF THE DRAWINGS

In this context, the following is shown, at times schematically:

FIG. 1 a supplementary circuit of a welding or cutting torch, for branching off electric energy, having a hose pack and a welding current source, in a first embodiment,

FIG. 2 the supplementary circuit as shown in FIG. 1, in a second embodiment,

FIG. 3 a welding torch with a sensor,

FIG. 4 a wiring diagram of the supplementary circuit,

FIG. 5 the wiring diagram as shown in FIG. 4, with a storage means for electric energy,

FIG. 6 a wiring diagram for another embodiment,

FIG. 7 a wiring diagram as shown in FIG. 6, with a storage means for electric energy,

FIG. 8 a wiring diagram for another embodiment of the supplementary circuit, with optical reverse-polarity display, and

FIG. 9 a wiring diagram as shown in FIG. 8, with a storage means for electric energy.

For the sake of clarity, identical components or those having the same effect are provided with the same reference numerals in the figures of the drawing shown below, making reference to an embodiment.

### DETAILED DESCRIPTION

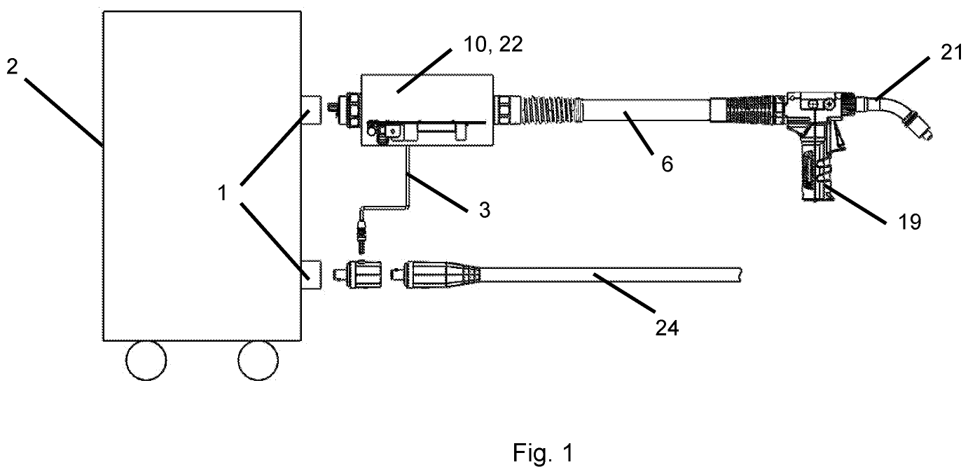

FIG. 1 shows a schematic view of a supplementary circuit 10 of a welding torch or cutting torch 21, having at least one connection device 1 to a welding current source 2 arranged on it. The connection device 1 can especially have two poles, i.e., plus and minus, whereby their polarity sign can change in case of an alternating voltage (AC). Electric energy and other media can be conveyed to the welding or cutting torch 21 via the connection device 1 and via process supply lines 3 in a hose pack 6.

The connection device 1 provided on the hose pack 6 serves to establish electrical and mechanical contact of the hose pack 6 with the welding current source 2.

The supply lines 3 that convey electric energy and other media such as shielding gas or welding wire to the welding or cutting torch 21 are arranged in the hose pack 6. After the hose pack 6 has been electrically connected to the welding current source 2, an electric current circuit—the welding current circuit—is closed. Electric energy to operate a peripheral device 4 is branched off from this current circuit.

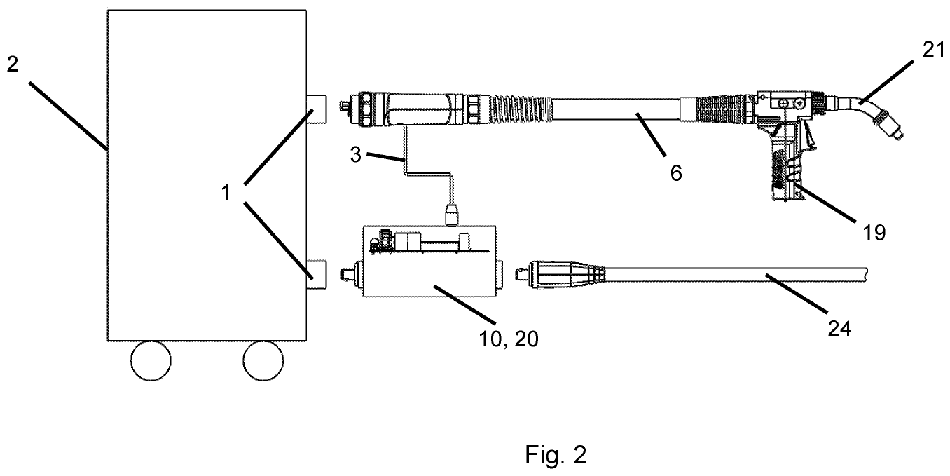

Electric energy to operate the peripheral device 4 is branched off from at least one electric process supply line 3. For purposes of branching off the electric energy, the supplementary circuit 10 in the present embodiment is electrically coupled in parallel to the welding current source 2 or to the welding current circuit, as can be seen in FIGS. 1 and 2. The term welding current circuit refers to the current circuit that is formed between the welding torch with the arc, the hose pack and the ground line of the welding device.

In particular, this is an electric current circuit connected in parallel that can process a highly variable input signal in terms of polarity, voltage and dynamics. Current and/or voltage frequencies within the range of direct current (in both directions), pulse-controlled direct current up to 200 kHz of pulsed frequency, or else alternating current up to 200 Hz can all be processed.

On the one hand, the supplementary circuit 10 for branching off electric energy can be provided on the hose pack 6; in particular, the supplementary circuit 10 can be integrated into an expanded connector housing 22 on the side associated with the machine, that is to say, on the side associated with the welding current source. This is advantageous because this housing 22 is already necessary anyway for the delivery of media, and also because the energy is supplied via the peripheral device 4. FIG. 1 illustrates this embodiment. In this context, the supplementary circuit 10 is arranged at the end of the hose pack 6 that is situated across from the torch 21.

On the other hand, the supplementary circuit 10 can also be connected outside of the hose pack 6 via process supply lines, as shown in FIG. 2. In this context, the supplementary circuit 10 is integrated into an adapter 20. This is preferably implemented in the electric ground line since, in contrast to the hose pack line, only electric current flows in it, but no other media such as gas, wire or water. Unlike circuits from the state of the art, the supplementary circuit 10 according to the invention is not based on an inductive operating principle, but rather on direct ohmic contact or on galvanic coupling.

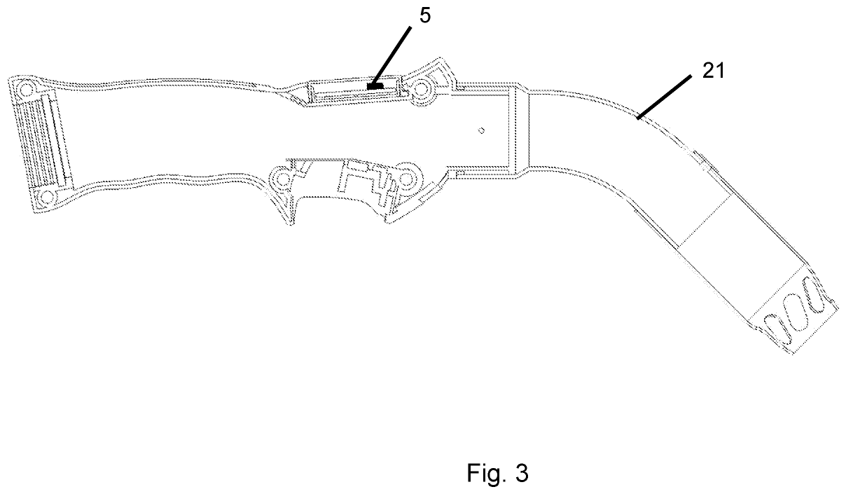

The peripheral devices 4 can be, for example, sensors 5, especially temperature sensors or gyro sensors, or else communication units such as Bluetooth transmitters or Bluetooth receivers, WLAN devices or a wire drive and the like. FIG. 3 shows a welding torch 21 with a sensor 5.

Moreover, it is also possible to supply fans, for instance, for fume extractors in welding applications.

However, it is likewise conceivable to also operate drive units 19 with this supply modality since the output of the autonomous energy supply is sufficient for this as well. FIGS. 1 and 2 depict such a drive 19.

Such peripheral devices 4 make high demands in terms of the speed of the circuit; in particular, a response time of less than 50 ms should be ensured. The supplementary circuit 10 according to the invention that serves to branch-off electric energy ensures this.

As a rule, the open-circuit voltage of the welding current source 2 is enough to provide a sufficiently high output for the peripheral device 4. The open-circuit voltage is usually 113 V or 141 V.

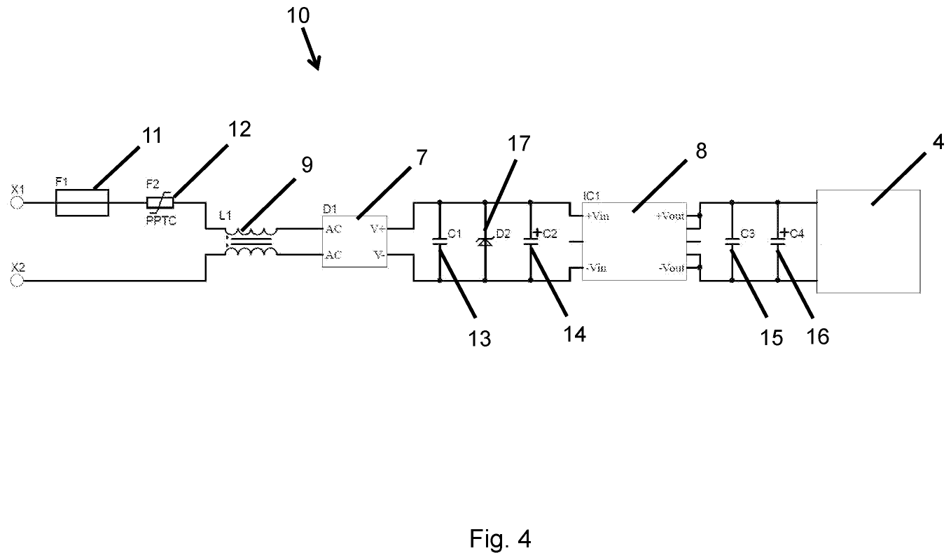

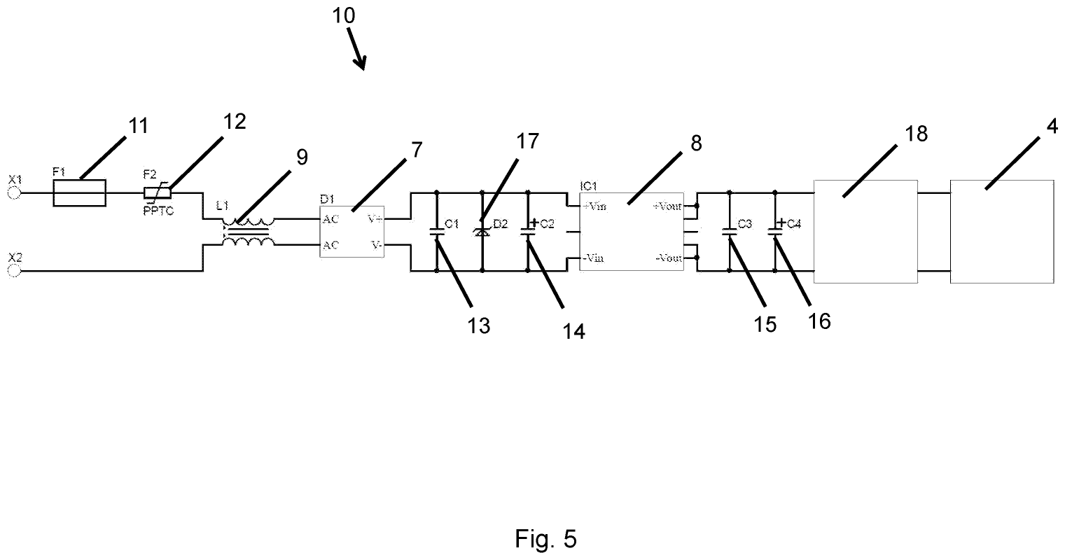

The depictions of the wiring diagrams of the electric circuit according to FIGS. 4 and 5 show that the supplementary circuit 10 has a rectifier 7, especially a bridge rectifier, to convert alternating voltage into direct voltage. Likewise provided is a switching DC-to-DC converter 8, especially a step-down converter, wherein the output voltage of the converter 8 is smaller than the value of the input voltage of the converter 8. The step-down converter is also referred to as a buck converter.

Thanks to this step-down converter, the voltage and current values common in welding devices can all be processed. These values are, for instance, 20 V/100 A to 30 V/300 A and 113 V or 141 V during no-load operation.

As an alternative, a DC-to-DC converter with a wide-range input and constant output voltage can also be employed.

In the present embodiment, the input voltage for the DC-to-DC converter 8 is the direct voltage that is output by the rectifier 7, so that the supplementary circuit 10 according to the invention allows direct (DC) as well as alternating (AC) voltage operation.

The supplementary circuit 10 has at least one overcurrent protector 11, 12 for cutting out the electric current if a stipulated current strength has been exceeded over a prescribed time. These overcurrent protectors 11, 12 respond especially to electric short circuits or overloads of the supplementary circuit 10.

As can likewise be seen in FIGS. 4 and 5, the supplementary circuit 10 has an inductor 9 for damping voltage peaks of the welding current source and at least one electric energy storage means 13, 14, 15, 16 is provided for feeding electric energy to the DC-to-DC converter 8 and/or for stabilizing the voltage of the supplementary circuit 10.

Moreover, the supplementary circuit 10 has a suppressor diode 17 to protect the DC-to-DC converter 8 against undesired voltage peaks.

As can likewise be seen in FIGS. 4 and 5, the overcurrent protectors 11, 12 and the inductor 9 are installed upstream from the DC-to-DC converter 8.

Moreover, the rectifier 7 as well as the at least one energy storage means 13, 14 and the suppressor diode 17 are installed upstream from the DC-to-DC converter 8.

At least one energy storage means 15, 16 is installed downstream from the DC-to-DC converter 8.

The embodiments shown in FIG. 4 and FIG. 5 differ in terms of an additional energy buffer 18 in the variant shown in FIG. 5. In particular, a super capacitor 18 can be provided for buffering electric energy.

The input signal is filtered as soon as the supplementary circuit 10 has been connected to the process supply lines 3. This takes place irrespectively of whether the input voltage into the supplementary circuit 10 is a direct voltage or an alternating voltage. Then, in any case, a direct voltage is present on the side associated with the output. Pulse-controlled input signals are smoothed and high voltages of up to 160 V can be processed.

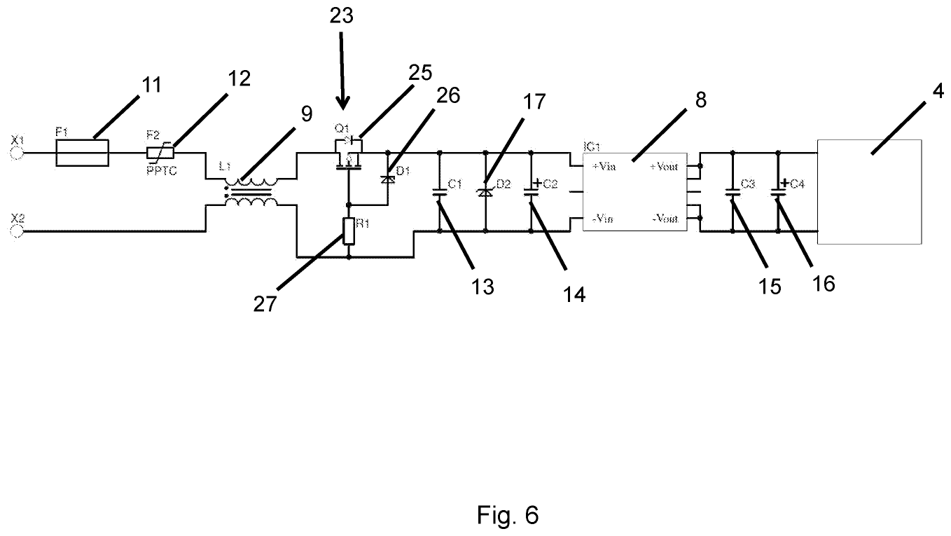

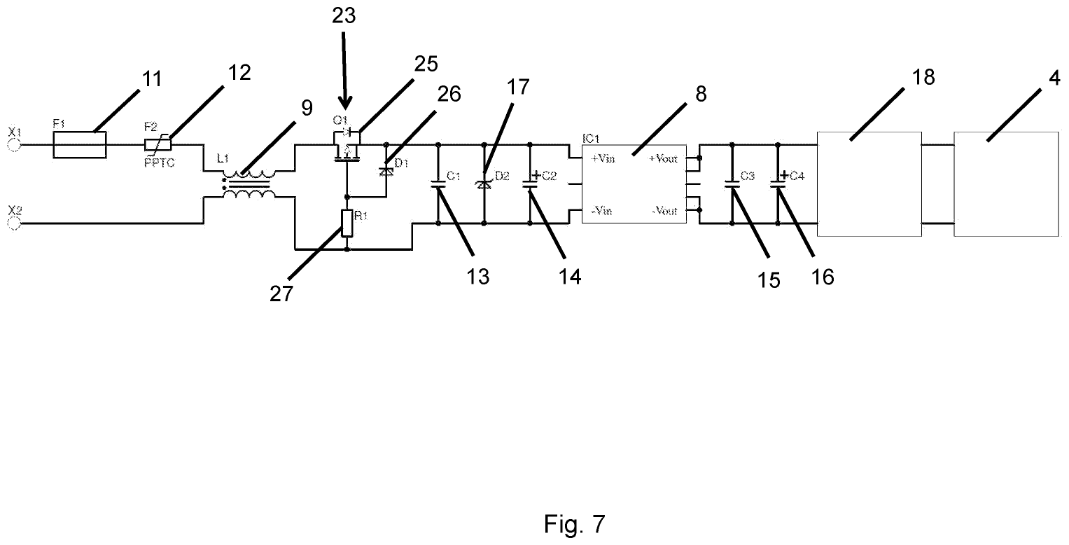

FIGS. 6 and 7 depict an alternative embodiment of the supplementary circuit 10. In this alternative, a reverse-polarity protector 23 is provided instead of the rectifier 7 in the circuit 10. In the embodiment shown here, reverse-polarity protection is implemented by means of a transistor 25, a Zener diode 26, and an electric resistor 27. In this manner, with the right connection and thus a correct polarity, the circuit delivers the requisite electric energy. As a rule, the polarity on the side associated with the torch is positive. Accordingly, if the user nevertheless reverses the polarity, the wrong connection will have the effect that no electric energy is released to the poles. It can be provided for the user to be informed about a fault.

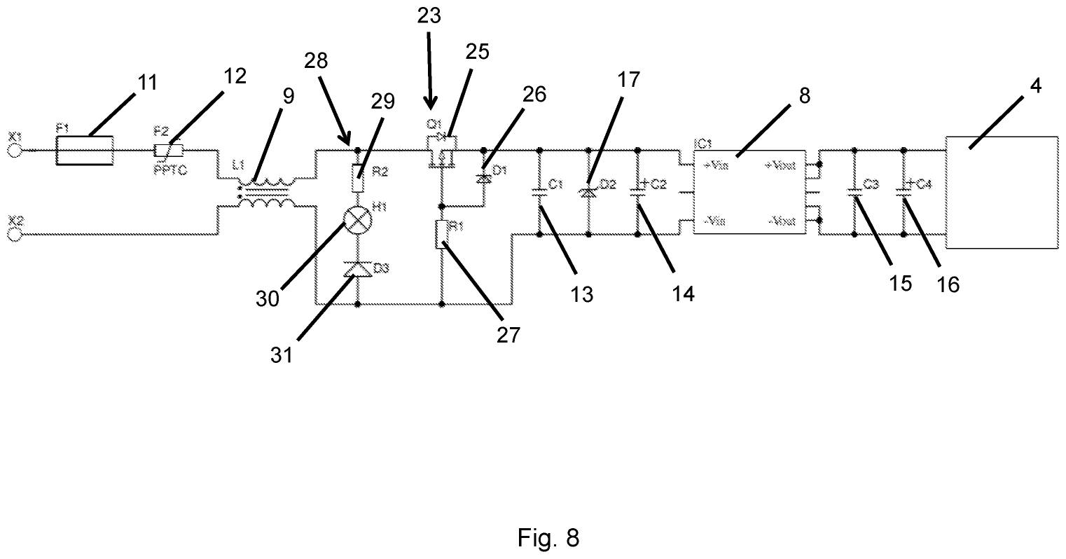

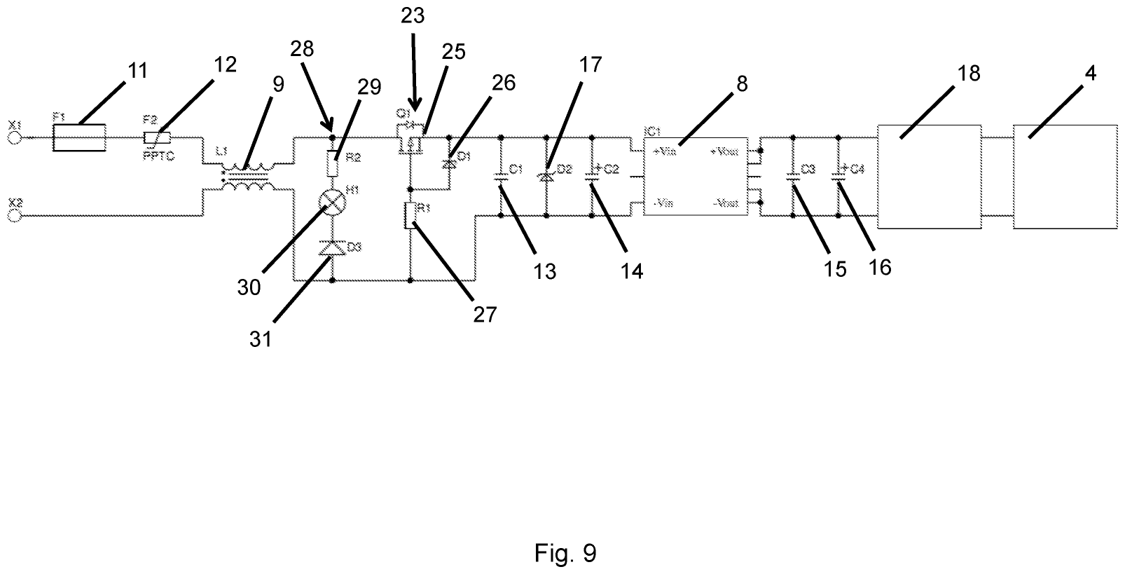

In the embodiment shown in FIGS. 8 and 9, such a reverse-polarity display is implemented by means of an optical display device 28. Here, a light element 30 comprising a resistor 29 and a diode 31 is integrated into the supplementary circuit 10. As an alternative or in addition within the scope of the invention, it is conceivable for erroneous reverse polarity to be indicated through the modality of an acoustic signal means.

The embodiments of the supplementary circuit 10 as shown in FIG. 7 and FIG. 9 differ from the circuit 10 as shown in FIG. 6 and FIG. 8 in that an energy buffer 18 is additionally provided for the variant shown in FIG. 7 and FIG. 9. As already elaborated upon, especially a super capacitor 18 can be provided for buffering electric energy.

### LIST OF REFERENCE NUMERALS

1 connection device
2 welding current source
3 process supply line
4 peripheral device
5 sensor
6 hose pack
7 rectifier
8 DC-to-DC converter
9 inductor
10 supplementary circuit
11 overcurrent protector
12 overcurrent protector
13 energy storage means
14 energy storage means
15 energy storage means
16 energy storage means
17 suppressor diode
18 super capacitor
19 drive unit
20 adapter
21 welding or cutting torch
22 connector housing
23 reverse-polarity protector
24 ground line
25 transistor
26 Zener diode
27 resistor
28 optical display device
29 resistor
30 light element
31 diode

1. A supplementary circuit (10) for supplying electric energy to a welding torch or cutting torch (21) as well as to a peripheral device (4), comprising:
at least one connection device (1) to a welding current source (2);
at least one process supply line (3) that is held in a hose pack (6) of the welding torch or cutting torch (21), wherein electric energy is conveyed to the welding torch or cutting torch via the connection device (1) and via the process supply line (3);
wherein electric energy for operating the peripheral device (4) is branched off from the at least one electric process supply line (3); and
wherein the supplementary circuit (10) provided for branching off electric energy is coupled electrically in parallel onto the welding current circuit.

2. The supplementary circuit (10) according to claim 1, further comprising a rectifier (7) to convert alternating voltage into direct voltage.

3. The supplementary circuit (10) according to claim 1, further comprising a reverse-polarity protector (23).

4. The supplementary circuit (10) according to claim 3, wherein the reverse-polarity protector (23) has at least one transistor (25), at least one Zener diode (26), and at least one electric resistor (27).

5. The supplementary circuit (10) according to claim 3, further comprising an optical display device (28) and/or an acoustic signal means for indicating incorrect reverse polarity.

6. The supplementary circuit (10) according to claim 1, further comprising a switching DC-to-DC converter (8) or a step-down converter, wherein output voltage of the converter (8) can deviate from the input voltage of the converter (8).

7. The supplementary circuit (10) according to claim 6, further comprising a rectifier (7) to convert alternating voltage into direct voltage, wherein the input voltage for the DC-to-DC converter (8) is the direct voltage that is output by the rectifier (7).

8. The supplementary circuit (10) according to claim 1, further comprising at least one overcurrent protector (11), (12) for cutting out electric current if a predetermined current strength has been exceeded over a prescribed time such as may be experienced in case of electric short circuits or overloads.

9. The supplementary circuit (10) according to claim 1, further comprising an inductor (9) for damping voltage peaks of the welding current source.

10. The supplementary circuit (10) according to claim 1, further comprising at least one electric energy storage means (13), (14), (15), (16) configured to store electric charge in an electric field or else in an accumulator or a battery so that electric energy can be fed to the DC-to-DC converter (8) and/or voltage of the supplementary circuit (10) can be stabilized.

11. The supplementary circuit (10) according to claim 6, further comprising a suppressor diode (17) configured to protect the supplementary circuit (10) or the DC-to-DC converter of the supplementary circuit (10) against undesired voltage peaks.

12. The supplementary circuit (10) according to claim 1, further comprising an additional energy buffer or a super capacitor (18) for buffering electric energy.

13. The supplementary circuit (10) according to claim 6, further comprising at least one overcurrent protector (11), (12) for cutting out the electric current if a predetermined current strength has been exceeded over a prescribed time such as may be experienced in case of electric short circuits or overloads, wherein the overcurrent protector (11), (12) and the inductor (9) are installed upstream from the DC-to-DC converter (8).

14. The supplementary circuit (10) according to claim 7, further comprising a suppressor diode (17) configured to protect the supplementary circuit (10) or the DC-to-DC converter (8) of the supplementary circuit (10) against undesired voltage peaks, and further comprising at least one electric energy storage means (13), (14), wherein the rectifier (7) as well as the at least one energy storage means (13), (14) and the suppressor diode (17) are installed upstream from the DC-to-DC converter (8).

15. The supplementary circuit (10) according to claim 10, further comprising a switching DC-to-DC converter (8), wherein the at least one energy storage means (15), (16) is installed downstream from the DC-to-DC converter (8).

16. The supplementary circuit (10) according to claim 1, further comprising a connector housing (22) into which the supplementary circuit (10) is integrated, wherein the connector housing (22) is coupled to the welding current source (2).

17. The supplementary circuit (10) according to claim 1, further comprising an adapter (20) that is connected to the at least one electric supply line (3).

18. A hose pack (6) having a supplementary circuit (10) according to claim 1.

19. A hose pack having a supplementary circuit (10) according to claim 16.

20. The supplementary circuit (10) according to claim 1, wherein the peripheral device (4) is selected from the group consisting of: a sensor (5), a drive unit (19) and a control for a drive unit (19).
